(19) United States
(12) Patent Application Publication
(10) Pub. No.: US 2022/0261642 A1
(43) Pub. Date: Aug. 18, 2022

(54) ADVERSARIAL EXAMPLE DETECTION SYSTEM, METHOD, AND PROGRAM

(71) Applicant: NEC Corporation, Minato-ku, Tokyo (JP)

(72) Inventor: Kosuke YOSHIDA, Tokyo (JP)

(73) Assignee: NEC Corporation, Minato-ku, Tokyo (JP)

(21) Appl. No.: 17/630,643

(22) PCT Filed: Aug. 2, 2019
(86) PCT No.: PCT/JP2019/030458

§ 371 Date: Jan. 27, 2022

(51) Int. Cl. G06N 3/08; G06N 7/00

(52) U.S. Cl. CPC G06N 3/08; G06N 7/005

(57) ABSTRACT

An adversarial example detection system capable of detecting adversarial examples at a low computational cost is provided. The preparation unit 100 calculates an inverse matrix of a Gram matrix that is used in a process of approximating a deep learner to a Gaussian process. The output distribution calculation unit 222 calculates mean and variance of output values that are numerical values used for class determination for each class by using the inverse matrix of the Gram matrix, for each input observation data. The probabilistic margin calculation unit 223 calculates a probabilistic margin that is an index of variability of the output values based on the mean and variance of the output values, for each input observation data. The adversarial example detection unit 224 detects the adversarial example from the input observation data based on the probabilistic margin calculated for each input observation data.

### TECHNICAL FIELD

The present invention relates to an adversarial example detection system which detects adversarial examples, an adversarial example detection method, and an adversarial example detection program.

### BACKGROUND ART

There is a known determination system that uses a deep learner to determine which class a given observation data falls into.

A deep learner is a model (i.e., a neural network) that has been learned by deep learning.

Observation data to be determined to which class the observation data corresponds is input to the determination system, and the determination system determines the class to which the observation data corresponds by using a deep learner. One example of such a determination system is a face recognition system. For example, a face image obtained by photographing is input to the face recognition system as observation data. The face recognition system then determines who the person in the input face image is, for example, by treating each person as a class.

Although a face recognition system is illustrated here, a speaker recognition system, a biometric authentication system, an automatic driving car, and the like can also be cited as examples of determination systems. Each class that is a determination result is defined according to a class determination performed by the determination system.

In these various determination systems, security is important and highly accurate class determination is required.

However, the existence of adversarial examples is known. An adversarial example is data to which a small perturbation is added for the purpose of deriving a wrong determination result in a determination process using a deep learner. In other words, an adversarial example is data that causes a determination system that uses an appropriate deep learner (model) obtained by normal deep learning to derive a wrong determination result even if the appropriate deep learner is used. For example, image data of a person “A” but with a small perturbation causing a face recognition system using an appropriate deep learner to derive a determination result of person “B” is an example of an adversarial example.

NPL 1 describes a technique for detecting adversarial examples. The technique described in the NPL 1 obtains the uncertainty of input points using approximation by sampling, and detects adversarial examples based on the uncertainty.

NPL 2 and NPL 3 describe a method for obtaining the Gram matrix.

### CITATION LIST

### Non Patent Literature

NPL 1: Reuben Feinman, and 3 others, “Detecting Adversarial Samples from Artifacts,” [searched on Jul. 5, 2019], Internet <URL:https://arxiv.org/pdf/1703.00410.pdf>
NPL 2: Jaehoon Lee, and 5 others, “DEEP NEURAL NETWORKS AS GAUSSIAN PROCESS”, a conference paper at ICLR 2018, [searched on Jul. 5, 2019], Internet, <URL:https://openreview.net/pdf?id=B1EA-M-OZ>
NPL 3: Adria Garriga-Alonso, and 2 others, “DEEP CONVOLUTIONAL NETWORKS AS SHALLOW GAUSSIAN PROCESSES”, a conference paper at ICLR 2019, [searched on Jul. 5, 2019], Internet, <URL:https://openreview.net/forum?id=Bklfsi0cKm>

### SUMMARY OF INVENTION

### Technical Problem

Some determination systems, such as face recognition systems, biometric authentication systems, and automatic driving cars, are extremely important for social security and human lives and the like. Such important determination systems use deep learners to make determinations on given observation data. However, there are some adversarial examples in which elaborate perturbations are intentionally added for the purpose of deriving wrong determination results in the determination process using deep learners.

Therefore, when operating the determination system, it is necessary to detect adversarial examples accurately from a large amount of observation data input to the determination system.

However, in the technique described in the NPL 1, approximation by sampling is performed. The approximation by sampling has a very high computational cost. Therefore, it is not practical to use the technique described in the NPL 1 as a process to detect adversarial examples from a large amount of observation data.

Therefore, it is an object of the present invention to provide an adversarial example detection system, an adversarial example detection method, and an adversarial example detection program, which can detect adversarial examples at a low computational cost.

### Solution to Problem

An adversarial example detection system according to the present invention comprises: a preparation unit that calculates an inverse matrix of a Gram matrix that is used in a process of approximating a deep learner to a Gaussian process; and a detection unit that detects an adversarial example from observation data that is to be determined to which class the observation data corresponds by the deep learner, by using the inverse matrix of the Gram matrix, wherein the preparation unit comprises: a learning data storage unit that stores learning data; a deep learner storage unit that stores the deep learner and architecture information that indicates at least a number of layers and presence or absence of convolution in the deep learner; a Gram matrix calculation unit that calculates the Gram matrix based on the deep learner, the architecture information, and the learning data; and an inverse matrix calculation unit that calculates the inverse matrix of the Gram matrix, and wherein the detection unit comprises: a data input unit that receives an input of the observation data; an output distribution calculation unit that calculates mean and variance of output values that are numerical values used for class determination for each class by using the inverse matrix of the Gram matrix, for each input observation data; a probabilistic margin calculation unit that calculates a probabilistic margin that is an index of variability of the output values based on the mean and variance of the output values, for each input observation data; and an adversarial example detection unit that detects the adversarial example from the input observation data based on the probabilistic margin calculated for each input observation data.

An adversarial example detection method according to the present invention comprises: preparation processing of calculating an inverse matrix of a Gram matrix that is used in a process of approximating a deep learner to a Gaussian process; and detection processing of detecting an adversarial example from observation data that is to be determined to which class the observation data corresponds by the deep learner, by using the inverse matrix of the Gram matrix, wherein the preparation processing comprises: Gram matrix calculation processing of calculating the Gram matrix based on the deep learner, architecture information that indicates at least a number of layers and presence or absence of convolution in the deep learner, and learning data; and inverse matrix calculation processing of calculating the inverse matrix of the Gram matrix, and wherein the detection processing comprises: data input processing of receiving an input of the observation data; output distribution calculation processing of calculating mean and variance of output values that are numerical values used for class determination for each class by using the inverse matrix of the Gram matrix, for each input observation data; probabilistic margin calculation processing of calculating a probabilistic margin that is an index of variability of the output values based on the mean and variance of the output values, for each input observation data; and adversarial example detection processing of detecting the adversarial example from the input observation data based on the probabilistic margin calculated for each input observation data.

An adversarial example detection program according to the present invention causes a computer to perform: preparation processing of calculating an inverse matrix of a Gram matrix that is used in a process of approximating a deep learner to a Gaussian process; and detection processing of detecting an adversarial example from observation data that is to be determined to which class the observation data corresponds by the deep learner, by using the inverse matrix of the Gram matrix, wherein the adversarial example detection program causes the computer to perform, in the preparation processing, Gram matrix calculation processing of calculating the Gram matrix based on the deep learner, architecture information that indicates at least a number of layers and presence or absence of convolution in the deep learner, and learning data; and inverse matrix calculation processing of calculating the inverse matrix of the Gram matrix, and wherein the adversarial example detection program causes the computer to perform, in the detection processing, data input processing of receiving an input of the observation data; output distribution calculation processing of calculating mean and variance of output values that are numerical values used for class determination for each class by using the inverse matrix of the Gram matrix, for each input observation data; probabilistic margin calculation processing of calculating a probabilistic margin that is an index of variability of the output values based on the mean and variance of the output values, for each input observation data; and adversarial example detection processing of detecting the adversarial example from the input observation data based on the probabilistic margin calculated for each input observation data.

### Advantageous Effects of Invention

According to the present invention, adversarial examples can be detected with a low computational cost.

### BRIEF DESCRIPTION OF DRAWINGS

FIG. 1 It depicts a block diagram showing a configuration example of an adversarial example detection system of an example embodiment of the present invention.

FIG. 2 It depicts a flowchart showing an example of the processing process of the preparation unit.

FIG. 3 It depicts a flowchart shows an example of the processing process of the detection unit.

FIG. 4 It depicts a schematic block diagram showing an example of a computer configuration of the adversarial example detection system of the present invention.

FIG. 5 It depicts a block diagram showing an overview of the adversarial example detection system of the present invention.

### EXAMPLE EMBODIMENTS

An example embodiment of the present invention is described below with reference to the drawings.

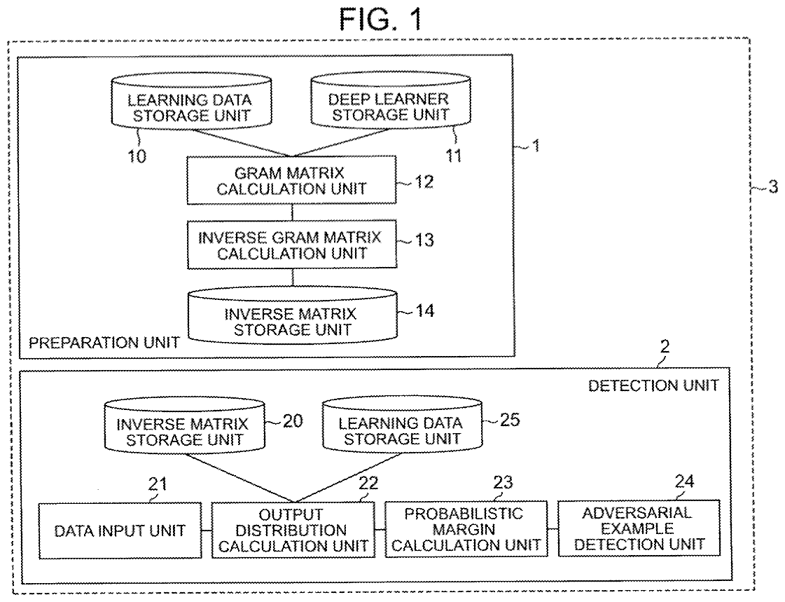

FIG. 1 is a block diagram illustrating a configuration example of an adversarial example detection system of an example embodiment of the present invention.

The adversarial example detection system 3 of the present example embodiment includes a preparation unit 1 and a detection unit 2. The adversarial example detection system 3 may be realized, for example, by a single computer including the preparation unit 1 and the detection unit 2. The adversarial example detection system may also comprise the preparation unit 1 and the detection unit 2, each of which is realized by a separate computer.

The detection unit 2 may be provided, for example, as a part of a determination system for determining which class the input observation data corresponds to.

The each class is each of the multiple types of items that are predetermined as items to which the input observation data may correspond.

The preparation unit 1 calculates the Gram matrix used in the process of approximating the deep learner to a Gaussian process, and also calculates the inverse matrix of the Gram matrix. The detection unit 2 detects adversarial examples from the input observation data using the inverse matrix of the Gram matrix. The input observation data is the data to be determined to which class it corresponds by using the deep learner.

The observation data is the data obtained by observation. The observation data is input to the determination system as data to determine which class the data corresponds to, or is used for learning of the deep learner. The observation data used for learning the deep learner is referred to as learning data.

The preparation unit 1 includes a learning data storage unit 10, a deep learner storage unit 11, a Gram matrix calculation unit 12, an inverse Gram matrix calculation unit 13, and an inverse matrix storage unit 14.

The learning data storage unit 10 is a storage device that stores observation data (i.e., learning data) used for learning the deep learner.

It is assumed that the observation data (learning data) stored by the learning data storage unit 10 does not include any adversarial examples.

Also, a deep learner (model. Also referred to as a neural network.) learned by deep learning using the learning data stored by the learning data storage unit 10 is used in the determination system.

The deep learner storage unit 11 is a storage device that stores a deep learner learned by deep learning using the learning data described above and architecture information of the deep learner. The architecture information of the deep learner indicates at least the number of layers and the presence or absence of convolution in the deep learner.

The Gram matrix calculation unit 12 calculates a Gram matrix to be used in the process of approximating the above deep learner to a Gaussian process. The Gram matrix calculation unit 12 calculates a Gram matrix to be used in the process of approximating the deep learner to a Gaussian process by approximating the deep learner to a Gaussian process. At this time, the Gram matrix calculation unit 12 calculates the Gram matrix based on the learning data stored in the learning data storage unit 10 and the deep learner and its architecture information stored in the deep learner storage unit 11.

The Gram matrix calculation unit 12 performs pre-processing on the learning data stored in the learning data storage unit 10. This pre-processing will be described later.

The Gram matrix calculation unit 12, for example, obtains the component of the i-th row and j-th column of the Gram matrix using the i-th learning data and the j-th learning data. The method for calculating the Gram matrix in this way may be, for example, the method described in NPL 2 or NPL 3.

For example, the Gram matrix calculation unit 12 generates a function that outputs a Gram matrix with the learning data as an input based on the deep learner and its architecture information. Then, the Gram matrix calculation unit 12 calculates the Gram matrix by inputting the learning data to the function.

However, the method by which the Gram matrix calculation unit 12 calculates the Gram matrix is not limited to the methods described in the NPL 2 and NPL 3, and the Gram matrix calculation unit 12 may calculate the Gram matrix in other ways.

The Gram matrix calculation unit 12 may use the result of adding a constant for stabilizing the inverse matrix calculation to the diagonal components of the calculated Gram matrix as the Gram matrix to be calculated for the inverse matrix. For example, let K be the Gram matrix calculated by using the learning data without using the observation data (observation data input from the outside) that is the target of the class determination. After calculating the Gram matrix K, the Gram matrix calculation unit 12 may calculate K+εI and use K+εI as the Gram matrix to be calculated for the inverse matrix. Here, c is a constant to stabilize the inverse matrix calculation, and I is the unit matrix.

The inverse Gram matrix calculation unit 13 calculates the inverse matrix of the Gram matrix calculated by the Gram matrix calculation unit 12. Hereinafter, when a matrix is denoted by “A”, the inverse matrix of the matrix A is denoted by inv(A). For example, the inverse Gram matrix calculation unit 13 calculates inv(K+εI).

The inverse Gram matrix calculation unit 13 stores the inverse matrix of the Gram matrix in the inverse matrix storage unit 14.

The inverse matrix storage unit 14 is a storage device that stores the inverse matrix of the Gram matrix calculated by the inverse Gram matrix calculation unit 13. In this example, the case where the inverse matrix storage unit 14 stores inv(K+εI) is taken as an example.

The detection unit 2 includes an inverse matrix storage unit 20, a data input unit 21, a learning data storage unit 25, an output distribution calculation unit 22, a probabilistic margin calculation unit 23, and an adversarial example detection unit 24.

The inverse matrix storage unit 20 is a storage device that stores the inverse matrix of the Gram matrix calculated by the inverse Gram matrix calculation unit 13. That is, the inverse matrix storage unit 20 stores the inverse matrix of the Gram matrix (in this example, inv(K+εI)) in the same manner as the inverse matrix storage unit 14 included in the preparation unit 1.

For example, the preparation unit 1 may send the inverse matrix of the Gram matrix stored in the inverse matrix storage unit 14 to the detection unit 2, and the detection unit 2 may store the inverse matrix of the Gram matrix in the inverse matrix storage unit 20. Alternatively, the operator may operate to copy the inverse matrix of the Gram matrix stored in the inverse matrix storage unit 14 to the inverse matrix storage unit 20. The method of storing the inverse matrix of the Gram matrix in the inverse matrix storage unit 20 may be other than the above.

If the adversarial example detection system 3 is realized by a single computer including the preparation unit 1 and the detection unit 2, the detection unit 2 may access the inverse matrix storage unit 14 without the inverse matrix storage unit 20.

The data input unit 21 receives an input of observation data in which it is determined which class the data corresponds to by the deep learner. In other words, the data input unit 21 accepts the input of observation data. The observation data input to the data input unit 21 is not observation data used for learning, and differs in this respect from the observation data (learning data) stored by the learning data storage unit 10.

In addition, as described above, it has been confirmed that the observation data (learning data) stored by the learning data storage unit 10 does not include any adversarial examples. On the other hand, it is possible that there are adversarial examples in the observation data input to the data input unit 21.

In addition, the data input unit 21 performs pre-processing on the input observation data. This pre-processing will be described later.

The learning data storage unit 25 is a storage device that stores learning data in the same manner as the learning data storage unit 10 in the preparation unit 1. That is, the learning data storage unit 25 stores learning data used for learning the deep learner. Assume that it is confirmed that the learning data stored by the learning data storage unit 25 does not include any adversarial examples.

As described above, the class is each of the multiple types of items that are predetermined as items to which the input observation data may correspond. In addition, a label corresponding to the class is predetermined for each class. In the present example embodiment, it is assumed that the label for each class is a number. The learning data storage unit 25 also stores the labels predetermined for each class in advance, respectively. Hereinafter, the label predetermined for each class is denoted by the sign y.

The output distribution calculation unit 22 calculates the mean and variance of the output value for each one of the observation data input to the data input unit 21 by using the inverse matrix of the Gram matrix stored in the inverse matrix storage unit 20. The output value is a numerical value obtained by inputting the observation data into the determination system, and is a numerical value used for determining to which class the observation data corresponds.

The output distribution calculation unit 22 calculates the mean and variance of the output values for each class for each input observation data. The following is an example of the operation in which the output distribution calculation unit 22 calculates the mean and variance of the output values for each class.

Let k be the Gram matrix calculated by using both the learning data and the observation data (observation data input via the data input unit 21) that is the target of the class determination. Also, let k_ be the Gram matrix calculated by using the observation data (observation data input via the data input unit 21) that is the target of the class determination without using the learning data.

The output distribution calculation unit 22 calculates the Gram matrix k and the Gram matrix k_ for each one observation data input via the data input unit 21. The output distribution calculation unit 22 calculates the Gram matrix k by using the one observation data and the learning data stored in the learning data storage unit 25. The output distribution calculation unit 22 also calculates the Gram matrix k_ by using the one observation data. The method for calculating the Gram matrix may be, for example, the method described in NPL 2 or NPL 3.

Then, the output distribution calculation unit 22 calculates, for each class, the mean of the output values by using the Gram matrix k calculated by using the observation data, for each one of the observation data input via the data input unit 21. The output distribution calculation unit 22 may, for example, obtain the mean of the output values by calculating the equation (1) shown below.

k*inv(K+εI)*y (1)

The * in equation (1) represents a product. This is also the case in equation (2) described below.

The label y is defined for each class. Accordingly, by performing the calculation of equation (1) using the label y that is defined for each class, the output distribution calculation unit 22 calculates the mean of the output values for each class. Note that the output distribution calculation unit 22 can read the label y from the learning data storage unit 25 when performing the calculation of equation (1).

The output distribution calculation unit 22 calculates the variance of the output values for each class by using the Gram matrix k_ and the Gram matrix k calculated by using the observation data, for each one of the observation data input via the data input unit 21. The output distribution calculation unit 22 may, for example, calculate the variance of the output values by calculating equation (2) shown below.

k_*inv(K+εI)*k (2)

In equation (2), unlike equation (1), the label y defined for each class is not used. Therefore, the variance of the output values calculated for each class does not change regardless of the class. In other words, the variance of the output values is the same for each class.

When calculating equation (1) and equation (2), the output distribution calculation unit 22 may read inv(K+εI) from the inverse matrix storage unit 20.

The probabilistic margin calculation unit 23 calculates a probabilistic margin, which is an index of the variability of the output values, based on the mean and variance of the output values, for each one of the observation data input via the data input unit 21. An example of the calculation of the probabilistic margin is shown below.

In the case of focusing on one observation data, the mean of the output values calculated for the class with the highest likelihood to which the observation data corresponds is denoted as μa, and the variance of the output values calculated for that class is denoted as σa². The mean of the output values calculated for the class with the second highest likelihood to which the observation data corresponds is denoted as μb, and the variance of the output values calculated for that class is denoted as σb².

The method of identifying the class with the first highest likelihood to which the observation data in focus corresponds and the class with the second highest likelihood to which the observation data corresponds is not particularly limited. For example, the probabilistic margin calculation unit 23 may maintain a deep learner and identify those classes based on the observation data being focused on and the deep learner. Alternatively, those classes may be identified in other ways.

Here, it can be assumed that for adversarial examples, the uncertainty of the class to which the observation data is determined to corresponds is high, and for regular observation data, the uncertainty of the class to which the observation data is determined to corresponds is low. Under this assumption, the probabilistic margin can be determined, for example, as shown in equation (3) below. Here, the probabilistic margin is denoted by the sign M.

M=(μa−μb)/(σa²+σb²) (3)

The probabilistic margin calculation unit 23 may calculate the probabilistic margin M by the calculation of equation (3). However, the probabilistic margin may be determined by an equation other than equation (3).

When the uncertainty is high, the probabilistic margin M takes a small value because the difference between μa and μb is small and the variance is large. In other words, the probabilistic margin M calculated for the adversarial example takes a small value.

The adversarial example detection unit 24 detects an adversarial example from each of the input observation data based on a probabilistic margin calculated for each one of the input observation data via the data input unit 21.

For example, the adversarial example detection unit 24 may determine, for each observation data, whether the probabilistic margin M calculated by the adversarial example detection unit 24 is less than or equal to a predetermined threshold, and detect the observation data for which the probabilistic margin M is less than or equal to the threshold as an adversarial example. On the other hand, the adversarial example detection unit 24 may determine that the observation data for which the probabilistic margin M is greater than the threshold is normal observation data.

As mentioned above, the adversarial example detection system 3 may be realized by a single computer, for example, including the preparation unit 1 and the detection unit 2. In this case, the Gram matrix calculation unit 12, the inverse Gram matrix calculation unit 13, the output distribution calculation unit 22, the probabilistic margin calculation unit 23, and the adversarial example detection unit 24 may be realized, for example, by a CPU (Central Processing Unit) of the computer operating according to the adversarial example detection program. In this case, the CPU may read the adversarial example detection program from a program recording medium such as a program storage device of the computer, and operate as the Gram matrix calculation unit 12, the inverse Gram matrix calculation unit 13, the output distribution calculation unit 22, the probabilistic margin calculation unit 23, and the adversarial example detection unit 24 according to the program. The data input unit 21 is realized, for example, by a data input interface of the computer and the CPU of the computer operating according to the adversarial example detection program. Also, the learning data storage unit 10, the deep learner storage unit 11, the inverse matrix storage unit 14, the inverse matrix storage unit 20, and the learning data storage unit 25 are realized, for example, by a storage device included in the computer.

The adversarial example detection system 3 may also comprise a configuration in which the preparation unit 1 and the detection unit 2 are realized by separate computers. In this case, the Gram matrix calculation unit 12 and the inverse Gram matrix calculation unit 13 are realized, for example, by a CPU of the computer for the preparation unit that operates according to a program for the preparation unit. In this case, the CPU may read the program for the preparation unit from a program storage medium such as a program storage device of the computer for the preparation unit, and operate as the Gram matrix calculation unit 12 and the inverse Gram matrix calculation unit 13 according to the program. Also, the learning data storage unit 10, the deep learner storage unit 11, and the inverse matrix storage unit 14 are realized, for example, by a storage device included in the computer for the preparation unit. Also, the output distribution calculation unit 22, the probabilistic margin calculation unit 23, and the adversarial example detection unit 24 are realized, for example, by a CPU of the computer for the detection unit operating according to a program for the detection unit. In this case, the CPU may read the program for the detection unit from a program recording medium such as a program storage device of the computer for the detection unit, and operate as the output distribution calculation unit 22, the probabilistic margin calculation unit 23, and the adversarial example detection unit 24 according to the program. The data input unit 21 is realized, for example, by a data input interface of the computer for the detection unit and the CPU of the computer for the detection unit operating according to the program for the detection unit. The inverse matrix storage unit 20 and the learning data storage unit 25 are realized by a storage device included in the computer for the detection unit.

Next, the processing process of the present example embodiment will be described. The detailed explanation is omitted for the matters already explained.

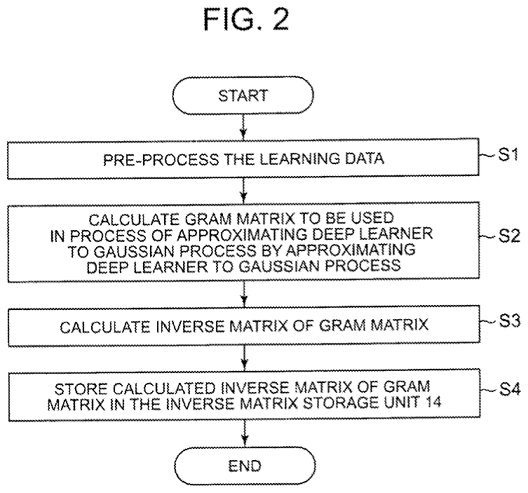

FIG. 2 is a flowchart showing an example of a processing process of the preparation unit 1 of the present example embodiment. In this example, the observation data is the data used for face recognition in a face recognition system, and therefore, the learning data is an image of a human face.

First, the Gram matrix calculation unit 12 pre-processes the learning data (step S1). As described above, when the learning data is an image of a human face, an example of the preprocessing is to delete the background portion from the image stored as the learning data and to crop only the image of the portion corresponding to the face.

The pre-processing in step S1 is not limited to the above examples. For example, the Gram matrix calculation unit 12 may perform smoothing of the learning data or interpolation of missing values of the learning data as pre-processing of the learning data.

After step S1, the learning data after preprocessing is used.

Next to step S1, the Gram matrix calculation unit 12 calculates a Gram matrix to be used in the process of approximating the deep learner to a Gaussian process by approximating the deep learner to a Gaussian process (step S2).

Next, the inverse Gram matrix calculation unit 13 calculates the inverse matrix of the Gram matrix (step S3).

Then, the inverse Gram matrix calculation unit 13 stores the inverse matrix of the Gram matrix calculated in step S3 in the inverse matrix storage unit 14 (step S4).

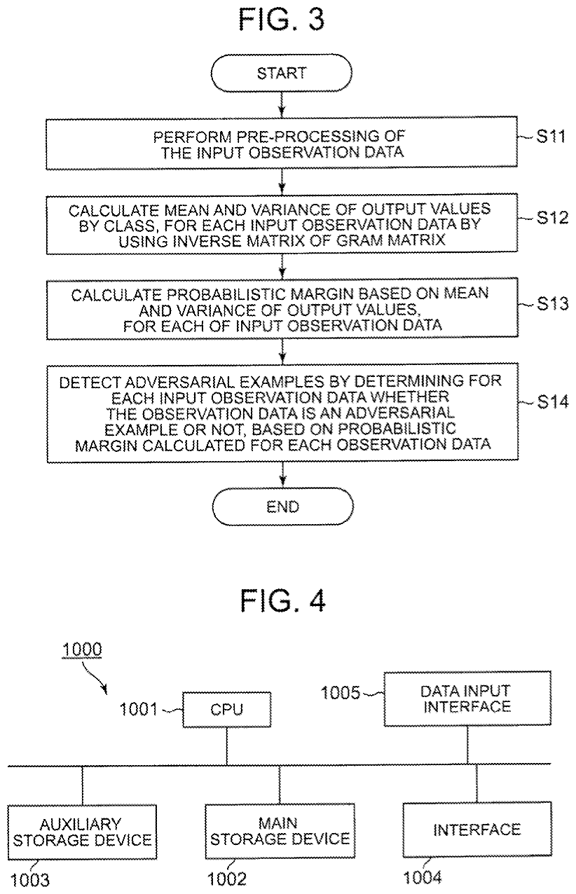

FIG. 3 is a flowchart showing an example of a processing process of the detection unit 2 of the present example embodiment. It is assumed that the inverse matrix storage unit 20 has already stored the inverse matrix of the Gram matrix stored in the inverse matrix storage unit 14 of the preparation unit 1.

The data input unit 21 performs pre-processing of the input observation data (step S11). The pre-processing of the input observation data includes, for example, smoothing processing of the observation data, interpolation processing of missing values of the observation data, and noise reduction processing of the observation data.

After step S11, the observation data after preprocessing is used.

Next to step S11, the output distribution calculation unit 22 calculates the mean and variance of the output values by class, for each input observation data by using the inverse matrix of the Gram matrix (step S12).

Next, the probabilistic margin calculation unit 23 calculates a probabilistic margin based on the mean and variance of the output values, for each of the input observation data (step S13). As described above, the probabilistic margin is an index of the variability of the output values.

Next, the adversarial example detection unit 24 detects adversarial examples by determining for each input observation data whether the observation data is an adversarial example or not, based on the probabilistic margin calculated for each observation data (step S14).

According to the present example embodiment, the adversarial example detection system 3 does not perform sampling. That is, the adversarial example detection system 3 of the present example embodiment detects the adversarial example without performing sampling, which has a high computational cost. Therefore, according to the present example embodiment, the adversarial example can be detected at a low computational cost.

Next, a variation of the example embodiment of the present invention will be described. In the above example embodiment, a case where the probabilistic margin calculation unit 23 calculates one probabilistic margin for each observation data is described. Specifically, a case in which the probabilistic margin calculation unit 23 calculates one probabilistic margin for each observation data according to equation (3) is described.

The probabilistic margin calculation unit 23 may calculate multiple types of probabilistic margins for each observation data input via the data input unit 21.

The foregoing equation (3) is an example of a method of determining a probabilistic margin, and the probabilistic margin may be determined as shown below in equation (4) and equation (5) in addition to the foregoing equation (3). The probabilistic margin determined by equation (4) is denoted by the sign M′. Also, the probabilistic margin determined by equation (5) is denoted by the sign M″.

M′=μa−μb (4)

M″=σa²+σb² (5)

Here, it is assumed that the probabilistic margin calculation unit 23 calculates three types of probabilistic margins M, M′, and M″ by calculating equation (3), equation (4), and equation (5), respectively, for each one of the observation data input via the data input unit 21.

However, in this variation, the probabilistic margin calculation unit 23 need only calculate multiple types of probabilistic margins for each observation data, and may calculate two types of probabilistic margins for each observation data by calculating any two of equations (3), (4), and (5). Alternatively, the probabilistic margin calculation unit 23 may calculate four or more types of probabilistic margins. Also, the probabilistic margin calculation unit 23 may calculate the probabilistic margin by a different equation than equation (3), equation (4), and equation (5).

The adversarial example detection unit 24 then detects an adversarial example from each of the input observation data based on multiple types of probabilistic margins (in this example, three types) calculated for each of the input observation data.

For example, it is assumed that a first threshold to be compared with a probabilistic margin M calculated by equation (3), a second threshold to be compared with a probabilistic margin M′ calculated by equation (4), and a third threshold to be compared with a probabilistic margin M″ calculated by equation (5) are predetermined.

The adversarial example detection unit 24 may determine for each observation data whether or not the predetermined condition is met, and detect the observation data that meets the predetermined condition as an adversarial example. On the other hand, the adversarial example detection unit 24 may determine that the observation data that does not satisfy the predetermined condition is normal observation data.

As the predetermined condition, for example, a condition that the probabilistic margin M calculated by equation (3) is less than or equal to a first threshold, that the probabilistic margin M′ calculated by equation (4) is less than or equal to a second threshold, and that the probabilistic margin M″ calculated by equation (5) is less than or equal to a third threshold may be used.

Alternatively, as the predetermined condition, for example, a condition where two or more (may be one or more) facts: that the probabilistic margin M calculated by equation (3) is less than or equal to a first threshold, that the probabilistic margin M′ calculated by equation (4) is less than or equal to a second threshold, and that the probabilistic margin M″ calculated by equation (5) is less than or equal to a third threshold are obtained.

This variation also detects adversarial examples without sampling, so it can detect adversarial examples with low computational cost.

FIG. 4 is a schematic block diagram showing an example of a computer configuration of the adversarial example detection system of the present invention. Here, it will first be described by taking as an example the case where the adversarial example detection system 3 is realized by a single computer including the preparation unit 1 and the detection unit 2. The computer 1000 includes a CPU 1001, a main storage device 1002, an auxiliary storage device 1003, an interface 1004, and a data input interface 1005.

The adversarial example detection system 3 is realized by a computer 1000. The operation of the adversarial example detection system 3 is stored in the auxiliary storage device 1003 in the form of a program. The CPU 1001 reads the program from the auxiliary storage device 1003, expands it to the main storage device 1002, and executes the processing described in the above example embodiment and variations thereof according to the program. In this case, the Gram matrix calculation unit 12, the inverse Gram matrix calculation unit 13, the output distribution calculation unit 22, the probabilistic margin calculation unit 23, and the adversarial example detection unit 24 are realized by the CPU 1001. The data input unit 21 is realized by the data input interface 1005 and the CPU 1001. The learning data storage unit 10, the deep learner storage unit 11, the inverse matrix storage unit 14, the inverse matrix storage unit 20, and the learning data storage unit 25 may be realized, for example, by the auxiliary storage device 1003 or by other storage devices.

The auxiliary storage device 1003 is an example of a non-transitory tangible medium. Other examples of a non-transitory tangible medium include a magnetic disk, an optical magnetic disk, a CD-ROM (Compact Disk Read Only Memory), a DVD-ROM (Digital Versatile Disk Read Only Memory), semiconductor memory, and the like. When the program is delivered to the computer 1000 by a communication line, the computer 1000 receiving the delivery may expand the program to the main memory device 1002 and execute the processing (operation) described in the above example embodiment and variations thereof according to the program.

When the preparation unit 1 and the detection unit 2 are each configured to be realized by separate computers, the computer for the preparation unit and the computer for the detection unit are each realized by a computer similar to the computer shown in FIG. 4. However, the computer for the preparation unit may not include a data input interface 1005. The computer for the preparation unit and the computer for the detection unit will also be described with reference to FIG. 4.

In the computer for the preparation unit, the operation of the preparation unit 1 is stored in the auxiliary storage device 1003 in the form of a program. The CPU 1001 reads the program from the auxiliary storage device 1003, expands it to the main memory device 1002, and executes the processing of the preparation unit 1 described in the above example embodiment according to the program. is executed. In this case, the Gram matrix calculation unit 12 and the inverse Gram matrix calculation unit 13 are realized by the CPU 1001. The learning data storage unit 10, the deep learner storage unit 11, and the inverse matrix storage unit 14 may be realized, for example, by the auxiliary storage device 1003, or by other storage devices.

In the computer for the detection unit, the operation of the detection unit 2 is stored in the auxiliary storage device 1003 in the form of a program. The CPU 1001 reads the program from the auxiliary storage device 1003, expands it to the main memory device 1002, and executes the processing of the detection unit 2 described in the above example embodiment and variations thereof according to the program. In this case, the output distribution calculation unit 22, the probabilistic margin calculation unit 23, and the adversarial example detection unit 24 are realized by the CPU 1001. The data input unit 21 is realized by the data input interface 1005 and the CPU 1001. The inverse matrix storage unit 20 and the learning data storage unit 25 may be realized, for example, by the auxiliary storage device 1003, or by other storage devices.

Some or all of each of the components may be realized by general purpose or dedicated circuitry, processors, or combinations thereof. These may comprise a single chip or a plurality of chips connected via a bus. Some or all of each component may be realized by a combination of the above-described circuitry, etc. and a program.

When some or all of each component is realized by a plurality of information processing apparatuses, circuits, or the like, the plurality of information processing apparatuses, circuits, or the like may be centrally located or distributed. For example, the information processing apparatuses, circuits, and the like may be implemented as a client-and-server system, a cloud computing system, and the like, each of which is connected via a communication network.

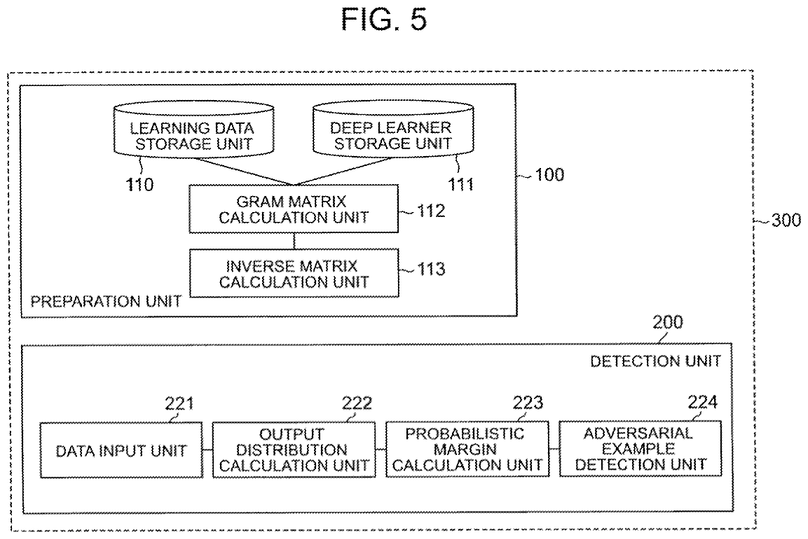

Next, an overview of the present invention will be described. FIG. 5 is a block diagram showing an overview of the adversarial example detection system of the present invention. The adversarial example detection system 300 of the present invention includes a preparation unit 100 and a detection unit 200.

The preparation unit 100 (e.g., the preparation unit 1) calculates an inverse matrix of a Gram matrix that is used in a process of approximating a deep learner to a Gaussian process.

The detection unit 200 (e.g., the detection unit 2) detects an adversarial example from observation data that is to be determined to which class the observation data corresponds by the deep learner, by using the inverse matrix of the Gram matrix.

The preparation unit 100 includes a learning data storage unit 110, a deep learner storage unit 111, a Gram matrix calculation unit 112, and an inverse matrix calculation unit 113.

The learning data storage unit 110 (e.g., the learning data storage unit 10) stores learning data.

The deep learner storage unit 111 (e.g., the deep learner storage unit 11) stores the deep learner and architecture information that indicates at least a number of layers and presence or absence of convolution in the deep learner.

The Gram matrix calculation unit 112 (e.g., the Gram matrix calculation unit 12) calculates the Gram matrix based on the deep learner, the architecture information, and the learning data.

The inverse matrix calculation unit 113 (e.g., the inverse Gram matrix calculation unit 13) calculates the inverse matrix of the Gram matrix.

The detection unit 200 includes a data input unit 221, an output distribution calculation unit 222, a probabilistic margin calculation unit 223, and an adversarial example detection unit 224.

The data input unit 221 (e.g., the data input unit 21) receives an input of the observation data.

The output distribution calculation unit 222 (e.g., the output distribution calculation unit 22) calculates mean and variance of output values that are numerical values used for class determination for each class by using the inverse matrix of the Gram matrix, for each input observation data.

The probabilistic margin calculation unit 223 (e.g., the probabilistic margin calculation unit 23) calculates a probabilistic margin that is an index of variability of the output values based on the mean and variance of the output values, for each input observation data.

The adversarial example detection unit 224 (e.g., the adversarial example detection unit 24) detects the adversarial example from the input observation data based on the probabilistic margin calculated for each input observation data.

Such a configuration can detect adversarial examples with low computational cost.

The probabilistic margin calculation unit 223 may be configured to calculate multiple types of probabilistic margins for each input observation data, and the adversarial example detection unit 224 may be configured to detect the adversarial example from the input observation data based on the multiple types of probabilistic margins calculated for each input observation data.

Although the present invention has been described above with reference to example embodiment, the present invention is not limited to the above example embodiment.

Various changes may be made to the structure and details of the present invention, that may be understood by those skilled in the art within the scope of the present invention.

### INDUSTRIAL APPLICABILITY

The present invention is suitably applied to an adversarial example detection system for detecting adversarial examples.

### REFERENCE SIGNS LIST

1 preparation unit
2 detection unit
3 adversarial example detection system
10 learning data storage unit
11 deep learner storage unit
12 Gram matrix calculation unit
13 inverse Gram matrix calculation unit
14 inverse matrix storage unit
20 inverse matrix storage unit
21 data input unit
22 output distribution calculation unit
23 probabilistic margin calculation unit
24 adversarial example detection unit
25 learning data storage unit

What is claimed is:

1. An adversarial example detection system comprising:
a preparation unit that calculates an inverse matrix of a Gram matrix that is used in a process of approximating a deep learner to a Gaussian process; and
a detection unit that detects an adversarial example from observation data that is to be determined to which class the observation data corresponds by the deep learner, by using the inverse matrix of the Gram matrix,
wherein the preparation unit comprises:
a learning data storage unit that stores learning data;
a deep learner storage unit that stores the deep learner and architecture information that indicates at least a number of layers and presence or absence of convolution in the deep learner;
a Gram matrix calculation unit that calculates the Gram matrix based on the deep learner, the architecture information, and the learning data; and
an inverse matrix calculation unit that calculates the inverse matrix of the Gram matrix, and
wherein the detection unit comprises:
a data input unit that receives an input of the observation data;
an output distribution calculation unit that calculates mean and variance of output values that are numerical values used for class determination for each class by using the inverse matrix of the Gram matrix, for each input observation data;
a probabilistic margin calculation unit that calculates a probabilistic margin that is an index of variability of the output values based on the mean and variance of the output values, for each input observation data; and
an adversarial example detection unit that detects the adversarial example from the input observation data based on the probabilistic margin calculated for each input observation data.

2. The adversarial example detection system according to claim 1,
wherein the probabilistic margin calculation unit
calculates multiple types of probabilistic margins for each input observation data, and
the adversarial example detection unit
detects the adversarial example from the input observation data based on the multiple types of probabilistic margins calculated for each input observation data.

3. An adversarial example detection method comprising:
preparation processing of calculating an inverse matrix of a Gram matrix that is used in a process of approximating a deep learner to a Gaussian process; and
detection processing of detecting an adversarial example from observation data that is to be determined to which class the observation data corresponds by the deep learner, by using the inverse matrix of the Gram matrix,
wherein the preparation processing comprises:
Gram matrix calculation processing of calculating the Gram matrix based on the deep learner, architecture information that indicates at least a number of layers and presence or absence of convolution in the deep learner, and learning data; and
inverse matrix calculation processing of calculating the inverse matrix of the Gram matrix, and
wherein the detection processing comprises:
data input processing of receiving an input of the observation data;
output distribution calculation processing of calculating mean and variance of output values that are numerical values used for class determination for each class by using the inverse matrix of the Gram matrix, for each input observation data;
probabilistic margin calculation processing of calculating a probabilistic margin that is an index of variability of the output values based on the mean and variance of the output values, for each input observation data; and
adversarial example detection processing of detecting the adversarial example from the input observation data based on the probabilistic margin calculated for each input observation data.

4. The adversarial example detection method according to claim 3,
wherein the probabilistic margin calculation processing comprises:
calculating multiple types of probabilistic margins for each input observation data, and
the adversarial example detection processing comprises:
detecting the adversarial example from the input observation data based on the multiple types of probabilistic margins calculated for each input observation data.

5. A non-transitory computer-readable recording medium in which an adversarial example detection program is recorded, the adversarial example detection program causing a computer to perform:
preparation processing of calculating an inverse matrix of a Gram matrix that is used in a process of approximating a deep learner to a Gaussian process; and
detection processing of detecting an adversarial example from observation data that is to be determined to which class the observation data corresponds by the deep learner, by using the inverse matrix of the Gram matrix,
wherein the adversarial example detection program causes the computer to perform, in the preparation processing,
Gram matrix calculation processing of calculating the Gram matrix based on the deep learner, architecture information that indicates at least a number of layers and presence or absence of convolution in the deep learner, and learning data; and
inverse matrix calculation processing of calculating the inverse matrix of the Gram matrix, and
wherein the adversarial example detection program causes the computer to perform, in the detection processing,
data input processing of receiving an input of the observation data;
output distribution calculation processing of calculating mean and variance of output values that are numerical values used for class determination for each class by using the inverse matrix of the Gram matrix, for each input observation data;
probabilistic margin calculation processing of calculating a probabilistic margin that is an index of variability of the output values based on the mean and variance of the output values, for each input observation data; and
adversarial example detection processing of detecting the adversarial example from the input observation data based on the probabilistic margin calculated for each input observation data.

6. The non-transitory computer-readable recording medium according to claim 5,
wherein the adversarial example detection program causes the computer to perform, in the probabilistic margin calculation processing,
calculating multiple types of probabilistic margins for each input observation data,
wherein the adversarial example detection program causes the computer to perform, in the adversarial example detection processing,
detecting the adversarial example from the input observation data based on the multiple types of probabilistic margins calculated for each input observation data.
